(19) United States
(12) Patent Application Publication
(10) Pub. No.: US 2015/0337246 A1
(43) Pub. Date: Nov. 26, 2015

(54) TWO-STAGE NEUTRALIZATION PROCESS FOR FORMING DETERGENT GRANULES, AND PRODUCTS CONTAINING THE SAME

(71) Applicant: The Procter & Gamble Company, Cincinnati, OH (US)

(72) Inventors: Rui SHEN, Beijing (CN); Daitao GENG, Beijing (CN); Paul R. MORT, III, Cincinnati, OH (US)

(21) Appl. No.: 14/718,119

(22) Filed: May 21, 2015

(30) Foreign Application Priority Data
May 23, 2014 (CN) PCT/CN2014/078209

(51) Int. Cl. C11D 11/04; C11D 17/00; C11D 17/06; C11D 1/22

(52) U.S. Cl. CPC C11D 11/04; C11D 1/22; C11D 17/0039; C11D 17/06

(57) ABSTRACT

The present invention relates to a two-stage neutralization process for forming detergent granules comprising a linear alkyl benzene sulphonate anionic surfactant with improved flowability and simplified processing requirements.

### FIELD OF THE INVENTION

The present invention relates to a method for forming detergent granules, particularly by a two-stage neutralization process for forming detergent granules comprising a linear alkyl benzene sulphonate (LAS) anionic surfactant, which are characterized by high surfactant activity, low residue acid, improved particulate flowability and simplified processing requirements.

### BACKGROUND OF THE INVENTION

When manufacturing detergent compositions containing anionic surfactants, the anionic surfactants are often manufactured by using acid precursors thereof, because such acid precursors of the anionic surfactants, especially linear alkyl benzene sulphonates (LAS), are much easier to handle, store and transport than the anionic surfactants themselves. Such acid precursors of the anionic surfactants are then converted into the anionic surfactants in the salt form by a neutralization process in which the acid precursors are mixed or contacted with a neutralizing agent, which is typically a strong or weak base compound, such as an alkali metal hydroxide, carbonate, or bicarbonate.

Neutralization of the acid precursors of the anionic surfactants can be carried out by using either an aqueous solution of a neutralizing agent or a solid dry neutralizing agent.

When the aqueous solution of the neutralizing agent is used, a viscous paste containing neutralized anionic surfactants and a substantial amount of free water is formed. Such paste form of the anionic surfactants is difficult to process. Further, detergent granules formed from such paste have high moisture contents and require substantial drying, which leads to significant increase in capital and processing costs.

When the solid dry neutralizing agent is used, the acid precursors of the anionic surfactants in substantially pure form (i.e., with little or no free water) are directly mixed with excessive amount of particulate neutralizing agent under “dry” conditions, i.e., in presence of little or no water. The acid precursors of the anionic surfactants are neutralized upon contact with the particulate neutralizing agent. However, the degree of neutralization from the dry neutralization process is limited by the surface area and particle size of the particulate neutralizing agent, because only the outer layer of the particulate neutralizing agent participates in the neutralization, while the inner part or core of the particulate neutralizing agent does not. Therefore, the smaller the particle size and the larger the surface area of the particulate neutralizing agent, the more complete is the neutralization. However, it is inevitable that some of the acid precursors of the anionic surfactants may not come into full contact with the particulate neutralizing agent, so the dry neutralization process may leave some residue acid precursors in the final detergent composition. The residue acid precursors are undesirable because they may cause degradation or destabilization of other ingredients in the detergent composition. Further, the dry neutralization process can only form detergent granules of relatively low surfactant activity level, e.g., less than 35%, due to the presence of a large amount of excessive dry neutralizing agent that is necessary to ensure sufficient neutralization of the acid precursors.

U.S. Pat. No. 6,660,708B discloses a continuous process for preparing a fluid detergent product containing an anionic surfactant by a two-step neutralization process, which include an initial step of feeding an initial liquid component containing the anionic surfactant acid precursor into a first mixing device with sufficient initial neutralizing agent to neutralize 25-75 wt % of the anionic surfactant acid precursor, followed by a subsequent step of feeding the partially neutralized process stream through one or more subsequent mixing devices with sufficient further neutralizing agent to achieve substantially complete neutralization of the anionic surfactant acid precursor. However, this two-step neutralization process described by U.S. Pat. No. 6,660,708B forms only a liquid or paste form of the neutralized anionic surfactant, i.e., the processing stream exiting the final mixing device is in a fluid form and is only suitable for forming a fluid detergent product. It cannot be used to form solid detergent granules.

EP641380B discloses a two-step neutralization process for forming pourable and free-flowing detergent granules containing anionic surfactants. Specifically, a flowable and pumpable mixture containing anionic surfactants is first formed by partial neutralization of one or more anionic surfactant acid precursors with a basic inorganic or organic neutralization medium, and such a partially neutralized mixture is then added to a solid or solid mixture that contains one or more basic solids to complete neutralization of the anionic surfactant acid precursors. The constituents are then granulated to thereby form pourable and free-flowing detergent granules. The initial neutralization step described by EP614380B preferably neutralizes about 20-40% of the anionic surfactant acid precursors, and in the example of EP614380B, a 34% partial neutralization of the anionic surfactant acid precursors was achieved during the initial neutralization step. Although the detergent granules formed by the two-step neutralization process disclosed by EP614380B are pourable and free-flowing, which is an improvement over the process disclosed by U.S. Pat. No. 6,660,708B, they nevertheless have limited flowability and are vulnerable to clumping and caking.

There is therefore a continuing need for a cost-effective agglomeration or granulation process for forming detergent granules containing anionic surfactants that have high surfactant activity, little or no residue acid precursor and improved flowability.

### SUMMARY OF THE INVENTION

The present invention provides a two-stage agglomeration or granulation process, including a first stage during which only a relatively small portion of the acid precursor of the anionic surfactant is neutralized (i.e., partial neutralization), followed by a second stage during which the remainder of the acid precursor of the anionic surfactant is neutralized to form detergent agglomerates or granules. The detergent granules formed by such a two-stage process of the present invention have high surfactant activity with little or no residue acid precursor and also exhibit significantly improvement in flowability.

Further, the specific degree of partial neutralization during the first stage is carefully selected to balance the amount of water introduced into the formulation, which include both water added with the liquid neutralizing agent during the first stage as well as water formed in situ by the neutralization reaction, with the need for improving the degree of final neutralization that can be achieved (which directly impact the surfactant activity level in the detergent granules so formed). Correspondingly, the amount of extra water added into the process stream is minimized, thereby providing an advantage of eliminating the need for subsequent drying. Still further, the specific degree of partial neutralization during the first stage balances heat generated by the neutralization reaction to ensure pumpability of the partial neutralization mixture so formed and at the same time to reduce or eliminate the need for cooling. In this manner, the equipment and operational requirements for the present process are significantly simpler than those for conventional processes, which is an additional advantage of the present invention.

In one aspect, the present invention is related to a process for preparing detergent granules, involving the steps of:
(a) mixing a liquid acid precursor of an anionic surfactant and a first neutralizing agent, wherein the liquid neutralizing agent is provided in an amount sufficient for neutralizing from about 5% to about 20% by weight of the liquid acid precursor of the anionic surfactant to form a partially neutralized mixture; and
(b) subsequently, mixing the partially neutralized mixture with a second neutralizing agent, wherein the second neutralizing agent is provided in an amount sufficient for substantially neutralizing the remaining liquid acid precursor of the anionic surfactant in the partially neutralized mixture to form detergent granules.

Preferably, the first neutralizing agent in step (a) is provided in an amount sufficient for neutralizing from about 10% to about 18%, preferably from about 15% to about 17%, by weight of the liquid acid precursor of the anionic surfactant. Such first neutralizing agent is preferably in a liquid form. In one specific embodiment of the present invention, the first neutralizing agent is an aqueous solution of an alkali metal hydroxide, which is preferably sodium hydroxide, at a concentration ranging from about 10 wt % to about 90 wt %, preferably from about 30 wt % to about 70 wt %, and more preferably from about 50 wt % to about 60 wt %. In another specific embodiment, the first neutralizing agent is a slurry of an alkali metal carbonate, preferably sodium carbonate, dispersed in a liquid carrier (such as water or a saturated caustic solution).

The liquid acid precursor of the anionic surfactant may be a C₁₀-C₂₀ linear alkyl benzene sulphonic acid, which is preferably provided in a substantially pure form.

In a particularly preferred but not necessary embodiment of the present invention, step (a) as mentioned hereinabove is carried out using one or more in-line mixers selected from the group consisting of static in-line mixers, dynamic in-line mixers, and combinations thereof.

The second neutralizing agent used in step (b) is preferably a solid powder of alkali metal carbonate or alkali metal bicarbonate, more preferably sodium carbonate, which is provided in a stoichiometrically excessive amount in relation to the remaining liquid acid precursor of the anionic surfactant in the partially neutralized mixture. Preferably, the second neutralizing agent is provided in an amount sufficient for forming detergent granules that contain from about 5% to about 70%, preferably from about 20% to about 65%, more preferably from about 35% to about 62%, and most preferably from about 45% to about 60% of the solid neutralizing agent by total weight of the detergent granules.

In a particularly preferred but not necessary embodiment of the present invention, step (b) is carried out using one or more batch mixers selected from the group consisting of paddle mixers, extruder mixers, ribbon blenders, ploughshare mixers, pin mixers, drum mixers, and combinations thereof.

The inventive process may not require any cooling device. An optional (but not necessary) dryer can be used to remove any free moisture from the detergent granules, leaving less than about 2 wt %, preferably less than about 1.6 wt %, more preferably less than about 1.2 wt % of free moisture in said dried detergent granules.

The process of the present invention can further include additional steps for removing over-sized particles and/or fines (i.e., undersized particles).

For example, the process may include the following additional steps for removing over-sized particles: (c) collecting over-sized particles having a particle size of more than about 1400 um, preferably more than about 1200 um, from the detergent granules after step (b); (d) grinding said over-sized particles to reduce their particle size; and (e) recycling the grinded over-sized particles back to the process stream.

The process may also include the following steps for removing fines or undersized particles: (f) collecting fine particles having a particle size of less than about 250 um, preferably less than about 200 um, from the detergent granules after step (b), preferably by using a fluid bed; and (g) recycling said fine particles back to the process stream.

The detergent granules formed by the above-described inventive process are characterized by high surfactant activity, which is desirable for forming detergent products of compact sizes. Specifically, the liquid acid precursor of the anionic surfactant can be provided in an amount sufficient for forming detergent granules containing more than about 30%, preferably more than about 35% and more preferably more than about 40%, of said anionic surfactant by total weight of the detergent granules.

The detergent granules may further contain one or more structurants, such as silica, zeolite, bentonite, cellulose or derivatives thereof, phosphates, acetates, polyacrylates, acrylate-maleate copolymers, magnesium sulfate and mixtures thereof. Such structurants can be added either into the partially neutralized mixture during step (b) at an amount ranging from about 0.5% to about 25% by total weight of the detergent granules. Alternatively, such structurants can be mixed with the detergent granules after step (b) to form a coating of structurant(s) thereover, which is present in an amount ranging from about 0.2% to about 5% by total weight of the coated detergent granules.

These and other aspects of the present invention will become more apparent upon reading the following detailed description of the invention.

### BRIEF DESCRIPTION OF THE DRAWINGS

FIGS. 1 and 2 are cross-sectional diagrams illustrating how a FlowDex equipment can be used to measure flowability of detergent granules formed by the process of the present invention.

### DETAILED DESCRIPTION OF THE INVENTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated.

As used herein, the term “surfactant” and/or the term “surfactant acid precursor” encompasses blends of different surfactant molecules and/or surfactant acid precursor molecules. As used herein, the term “liquid” refers to a fluid with a viscosity ranging from about 0.1 Pa·S to about 10 Pa·S (i.e., from about 100 cps to about 10,000 cps) when measured at about 50° C. and at a shear rate of about 25 s⁻¹.

As used herein, the term “substantial neutralization,” “substantially neutralized” or “substantially neutralizing” refers to neutralization of at least about 95 wt %, preferably at least about 98 wt %, more preferably at least about 99 wt %, and most preferably at least about 99.9 wt %, of all acid precursor of the anionic surfactant in a particular composition.

As used herein, the term “substantially pure” refers to a composition containing a specific ingredient at a concentration level of 95 wt % or above, preferably 98 wt % or above, and more preferably 99 wt % or above. Then such composition is deemed containing the specific ingredient in a substantially pure form.

As used herein, the term “free moisture” or “free water” refers to moisture or water that is not bound to a salt or compound in its respective hydrate form.

As used herein, the term “median particle size” refers to the Median Weight Particle Size (Dw50) of a specific particle as determined by the Sieve Test specified hereinafter using a sample of such particles. The term “particle size distribution” as used herein refers to a list of values or a mathematical function that defines the relative amount, typically by mass or weight, of particles present according to size, as measured also by the Sieve Test specified hereinafter.

### I. First Stage: Partial Neutralization

During the first stage of the inventive process, an acid precursor of an anionic surfactant is provided and mixed with a first neutralizing agent in an amount sufficient for neutralizing from about 5 wt % to about 20 wt % of the acid precursor of the anionic surfactant.

Suitable acid precursors of anionic surfactants are well known to those skilled in the art. Examples suitable for practicing the present invention include alkylbenzene sulphonic acid, particularly linear alkylbenzene sulphonic acid having an alkyl chain length of C8-C15; primary and secondary alkyl sulphuric acid, particularly C12-C15 primary alkyl sulphuric acid; alkyl ether sulphuric acid; olefin sulphonic acid; alkyl xylene sulphonic acid; dialkyl sulphosuccinic acid; and fatty acid ester sulphonic acid. In a preferred embodiment of the present invention, the liquid acid precursor of anionic surfactant is a linear alkylbenzene sulphonic acid (HLAS) having an alkyl chain length of C₈-C₁₅. Linear or branched primary alkyl sulphuric acid having 10 to 15 carbon atoms can also be used.

It is an essential element of the process of this invention that a relatively small portion of the liquid acid precursor of the anionic surfactant (preferably from about 5 wt % to about 20 wt %, more preferably from about 10 wt % to about 18 wt %, and most preferably from about 15 wt % to about 17 wt %) is neutralized during the first stage of the process. It has been discovered that such relatively lower degree of partial neutralization during the first stage of the two-stage process is able to produce detergent granules of higher surfactant activity and improved flowability in comparison with conventional processes. The resulting detergent granules contain little or no residue acid precursor, thereby minimizing the risk of acid degradation of other detergent actives in the formulation and ensuring satisfactory product stability. Further, the resulting detergent granules require no subsequent drying after the agglomeration or granulation process, thereby significantly reducing the capital investments and operation costs required for manufacturing.

The acid precursor of the anionic surfactant is preferably provided in a liquid form that is pumpable. Specifically, such anionic surfactant acid precursor is characterized by a viscosity ranging from about 0.1 Pa·S to about 10 Pa·S, preferably from about 0.1 Pa·S to about 5 Pa·S, more preferably from about 0.2 Pa·S to about 0.5 Pa·S, when measured at 50° C. and at a shear rate of 25 s⁻¹. It can be provided either in a substantially pure form, or as a solution containing from about 20 wt % to about 99 wt % of the anionic surfactant acid precursor in a liquid carrier. The liquid carrier can be water or any suitable inorganic or organic solvent. In a preferred embodiment of the present invention, an aqueous solution containing from about 50 wt % to about 98 wt %, more preferably from about 85 wt % to about 97 wt %, of HLAS is used.

The first neutralizing agent used during the first stage of the present process for partially neutralizing the liquid acid precursor of the anionic surfactant can be any base compound that is capable of reacting in situ with the acid precursor of the anionic surfactant to form the anionic surfactant in an appropriate salt form. Such first neutralizing agent can be readily selected from alkaline inorganic materials, alkaline earth inorganic materials, and mixtures thereof, among which water-soluble alkaline inorganic materials such as alkaline metal hydroxides, carbonates, bicarbonates and/or silicates are particularly preferred. Organic neutralizing agents may also be employed. A particularly preferred neutralizing agent is sodium hydroxide. Sodium carbonate and/or bicarbonate can also be used.

Preferably, the first neutralizing agent is also provided in a liquid form that is pumpable as mentioned hereinabove. For example, the first neutralizing agent can be provided in a slurry form or as a solution that contains a liquid carrier for either dispersing or solubilizing the first neutralizing agent. The liquid carrier is preferably water, but it can also be any suitable inorganic or organic solvent. Preferably, an aqueous solution of the first neutralizing agent is provided, which contains: (1) from about 10 wt % to about 90 wt %, preferably from 30 wt % to about 70 wt % and more preferably from about 50 wt % to about 60 wt % of the first neutralizing agent, and (2) from about 10 wt % to about 90 wt %, preferably from about 30 wt % to about 70 wt % and more preferably from about 40 wt % to about 50 wt % of water. In a particularly preferred embodiment of the present invention, an aqueous solution containing from about 50 wt % to about 60 wt % of sodium hydroxide is used for neutralizing the liquid HLAS. In another preferred embodiment of the present invention, a containing from about 30 wt % to about 80 wt % of sodium carbonate dispersed in a liquid carrier (preferably water, but can also be other known solvents or solutions, such as a caustic solution) is used for neutralizing the liquid HLAS.

Mixing of the anionic surfactant acid precursor and the neutralizing agent during the first stage can be carried out in any suitable mixer, either in-line or batch mixers, or either static or dynamic mixers. Suitable mixers include but are not limited to: static in-line mixers, dynamic in-line mixers, paddle mixers, extruder mixers, ribbon blenders, ploughshare mixers, pin mixers, drum mixers, and combinations thereof. Optionally, the mixture so formed is subsequently passing through a high shear mill, such as an Ytron Z-80 homogenizer or shearpump that is commercially available from Ytron Process Technology GmbH (Bad Endorf, Germany).

When both the anionic surfactant acid precursor and the neutralizing agent are in pumpable liquid form, an in-line mixer is preferably used for mixing these ingredients. The in-line mixer can be either static in-line mixer or dynamic in-line mixer.

Static mixers are well-known to the skilled person. They have to be capable of operating in a continuous process and of mixing fluids. Suitable mixers include static in-line mixers, for example Sulzer-type mixers. Particularly preferred are high shear static mixers, as for example, DN 50 from Sulzer comprising 12 static mixing elements, type SMX used for mixing high viscous materials. Static mixers are particularly preferred over dynamic mixers for the process of the present invention, as static mixers require lower capital investment. This is especially true for multi-stage high shear dynamic mixers and positive displacement pumps, which are much more expensive than static mixers used for the process of the present invention.

Preferably, the liquid anionic surfactant acid precursor is fed to the first of one or more static mixers together with the first neutralizing agent in liquid or slurry form during the first stage of partial neutralization. The first neutralizing agent is provided in an amount sufficient for neutralizing from about 5 wt % to about 20 wt % of the liquid anionic surfactant acid precursor. The liquid anionic surfactant acid precursor and the first neutralizing agent can be fed separately into the first of one or more static mixers, or alternatively they can be brought into contact with each other prior to the first of one or more static mixers. In the latter case, these two ingredients should only come into contact with each other at a position relatively close, in terms of time, to the first of one or more static mixers. Preferably, the time when these two ingredients are brought together into contact and the time when the mixture of these two ingredients enters the first of one or more static mixers should be less than 3 minutes, preferably less than 1 minute.

The mixture so formed, as it leaves the first of one or more static in-line mixers, contains anionic surfactant formed by reaction between a portion of the acid precursor and the first neutralizing agent, the remaining acid precursor, and water generated in situ by the neutralization reaction.

In another preferred embodiment of the present invention, two static in-line mixers are used. In such process set up, it is preferred that the two static in-line mixers are in series and that there is an additional liquid injection point located between the two static in-line mixers in series. Such additional liquid injection point can be used for the addition of other detergency components such as nonionic surfactants, or for the addition of a diluent. Such diluent can be selected from various compounds and include inorganic solvents, such as water. In a preferred embodiment of the present invention, the process is conducted in the absence of nonionic surfactants.

At the very minimum, the first stage of the present process requires the liquid acid precursor of the anionic surfactant and the first neutralizing agent as starting materials, which are stored in separate vessels and then pumped into the one or more static in-line mixers. However, the starting materials can also contain other components. Such additional components are preferably stored separately from the anionic surfactant acid precursor, the first neutralizing agent and each other. This allows a greater variety of surfactants to be prepared from the same starting materials.

Preferably, the anionic surfactant acid precursor, the first neutralizing agent and any additional component can be fed from their respective storage vessels into the process independently of each other. Additional components can be fed into the process at any appropriate stage, e.g. into any of the one or more static in-line mixer during the first stage to be mixed with the anionic surfactant acid precursor and the neutralizing agent, or subsequently into the partially neutralized mixture during the second stage of the process, or thereafter into the detergent granules already formed.

Although the various ingredients may be fed into the process by means of gravity, it is preferred, in the case of liquid ingredients which are pumpable, that a pumping device be used, preferably a positive displacement pump. Suitable pumps for this purpose include, for example, gear pumps and diaphragm pumps.

When other ingredients besides the anionic surfactant acid precursor and the neutralizing agent are added during the first stage of the process, they are preferably brought together and mixed with the anionic surfactant acid precursor in an additional process step preceding the first stage.

### II. Second Stage: Complete Neutralization

During the second, subsequent stage of the inventive process, the partially neutralized mixture formed by the first stage is mixed with an additional, second neutralizing agent, which is provided in an amount sufficient for substantially neutralizing all the remaining liquid acid precursor of the anionic surfactant to form detergent granules that contain fully neutralized anionic surfactant and are substantially free of the acid precursor thereof.

Such second stage is preferably carried out by a so-called “dry neutralization” step in which a liquid acid precursor of anionic surfactant is neutralized by direct contact with dry powders of the second neutralizing agent. The liquid acid precursor of anionic surfactant itself acts as a binder during this process, so no additional liquid binder is needed. Because the neutralization only occurs on the surface area of the particulate neutralizing agent, where the liquid acid precursor comes into contact with the neutralizing agent, a stoichiometrically excessive amount of the particulate neutralizing agent is required in order to ensure full neutralization of the liquid acid precursor in the mixture. The actual amount of the particulate neutralizing agent required for achieving full neutralization depends not only on the amount of the liquid acid precursor, but also the particle size of the neutralizing agent. The finer the particle size, the more surface area is available for neutralization, and the lesser amount is required.

The partially neutralized mixture exiting the first stage is preferably still in a liquid form or a semi-liquid or paste form that is pumpable, so it can be used as a binder during the second stage for mixing with one or more particulate ingredients to form detergent granules.

The additional, second neutralizing agent used during the second stage of the present process for completely neutralizing the remaining liquid acid precursor of the anionic surfactant in the partially neutralized mixture can be the same or different from the neutralizing agent used during the first stage, e.g., any base compound that is capable of reacting in situ with the acid precursor of the anionic surfactant can be used as the second neutralizing agent. Preferably but not necessarily, the second neutralizing agent used during the second stage of the present process is different from the first neutralizing agent used during the first stage. The second neutralizing agent can be readily selected from alkaline inorganic materials, alkaline earth inorganic materials, and mixtures thereof, among which water-soluble alkaline inorganic materials such as alkaline metal hydroxides, carbonates, bicarbonates and/or silicates are particularly preferred. Organic neutralizing agents may also be employed. A particularly preferred second neutralizing agent is sodium carbonate and/or sodium bicarbonate. Sodium hydroxide can also be used.

Preferably, the second neutralizing agent for the second stage neutralization is provided in a solid or particulate form in a stoichiometrically excessive amount sufficient for substantially neutralizing all the remaining acid precursor of the anionic surfactant in the partially neutralized mixture. More preferably, the second neutralizing agent is provided as a finely divided powder for dry neutralization of the partially neutralized mixture. For example, a solid neutralizing powder having a mean particle size ranging from about 0.1 to about 100 microns, preferably from 2 to about 25 microns, and more preferably from about 5 to 15 microns, is provided for use during the second stage. When the solid neutralizing powder is sodium carbonate, it is preferred that a coarser sodium carbonate particulate material is first provided, which is then grinded to form finer particles of reduced mean particle size.

In addition to solid powder of the second neutralizing agent, other powdery ingredients can also be added into the partially neutralized mixture during the second stage to form the detergent granules. For example, one or more particulate structurants selected from the group consisting of silica, zeolite, bentonite, cellulose or derivatives thereof, phosphates, acetates, polyacrylates, acrylate-maleate copolymers, magnesium sulfate, and mixtures thereof can be added into the partially neutralized mixture to form detergent granules that contains from about 0.5% to about 25% of such structurants by total weight of the detergent granules. A particularly preferred structure in the present invention is silica, which can be provided in the amount ranging from about 0.5% to about 15% by weight. Zeolite and/or bentonite can also be used, either separately or in combination with silica and/or in combination with each other.

Mixing of the partially neutralized mixture, the additional neutralizing agent and optionally other ingredients during the second stage can be carried out using any suitable mixer, either in-line or batch mixers, or either static or dynamic mixers, depending on the form of the ingredients added. When the partially neutralized mixture is in a liquid, semi-liquid or paste form and the additional neutralizing agent in a solid powder form, a batch mixer or agglomerator is preferably used to achieve agglomeration or granulation of the raw materials. Suitable batch mixers that can be used for agglomeration or granulation include, but are not limited to: paddle mixers, extruder mixers, ribbon blenders, ploughshare mixers, pin mixers, drum mixers, and combinations thereof.

In a particularly preferred embodiment of the present invention, the second stage of the present process is carried out in two sub-steps, during the first of which a high speed mixer is employed to mix the ingredients with a relatively short residence time from about 0.2 second to about 50 seconds to form a free-flowing powder, and during the second of which a moderate speed mixer is employed to further agglomerate the free-flowing powder into detergent granules of desired particle sizes, as described in U.S. Pat. No. 6,794,354B 1.

To achieve the desired dispersion of particulate ingredients and adsorption of liquid ingredients and form agglomerates or granules of satisfactory physical properties, it is necessary that the shear rate in the mixer be sufficiently high and proportional relative to the viscosity of the liquid ingredients. In a preferred embodiment, the mixer consists of a device with mixing tools operating at a tip speed of at least 5 m/s, and a narrow gap between the tool tip(s) and the mixer wall or other fixed element of less than 2 cm. Preferably, the mean residence time of the first mixer is in range from about 0.2 to about 50 seconds, more preferably from about 1 to about 30 seconds. Examples of the high speed mixer for carrying out the first sub-step are a LOdige CB Mixer manufactured by the LOdige company (Germany), a Turbilizer manufactured by Bepex Company (USA), and a Schugi Flexomatic (e.g., Model FX-160) manufactured by the Schugi company (Netherlands). Preferably, the particulate ingredients (including the solid neutralizing powders) and the liquid ingredients (including the partially neutralized mixture) are continuously and simultaneously introduced into the high speed mixer, which is operated at a shear rate sufficiently high to allow the liquid ingredients to disperse well and be absorbed onto the surface of the particulate ingredients, thereby forming free-flowing powders.

During the second sub-step, an additional mixer of moderate speed can be used to further agglomerating and granulating the free-flowing powders into detergent granules of desirable particle sizes, with or without additional powder and liquid ingredients being introduced into the formulation. Mixers suitable for carrying out the subsequent agglomerating and granulating steps include mixers with internal choppers, for example, a LOdige KM mixer manufactured by the LOdige company (Germany).

### III. Additional Optional Processing Steps

The process of the present invention can be used to make detergent granules that are suitable for use as-is, after addition of any adjunct detergent ingredients, as a detergent product. However, it may be preferred to further condition or treat the detergent granules via optional process steps.

One example of an additional process step is drying, in which a dryer can be employed to further remove free moisture from the detergent granules. Although the detergent granules formed by the first and second stages of the present process is sufficient dry and free-flowing that no additional drying step is necessary, it is nevertheless within the spirit of the present invention to employ drying devices to minimize the moisture or water content in the dried detergent granules to less than 2%, preferably less than 1.6%, and more preferably less than 1.2%. In a preferred embodiment of the present invention, the detergent granules prepared by the process of the present invention may be flash-dried. Flash-drying is a process step well known to the ordinary person skilled in the art. Alternatively, the detergent granules can be subjected to drying by an airlift or a fluid bed dryer.

Another example of an additional process step is the removal of oversized particles. Specifically, over-sized particles having a particle size larger than a desired parameter, e.g., larger than 1400 microns and preferably larger than 1200 microns, can be collected from the detergent granules after the second stage by using a screening apparatus or a sieving device, which are then grinded to reduce their particle size and recycled back into the process stream.

A still further example of an additional process step is the removal of fines or undersized particles. Specifically, fine particles having a particle size smaller less than a desired parameter, e.g., less than 250 microns or preferably less than 200 microns, are collected from the detergent granules after the second stage, preferably by elutriation from a device such as a fluidized bed dryer, a fluidized bed cooler, or any other suitable classification device, which are then recycled back to the process stream via an internal recycle stream.

The process of the present invention generally entails finishing the resulting detergent granules by a variety of processes including spray-drying and/or admixing other conventional detergent ingredients. For example, the finishing steps may include spraying perfumes, brighteners and enzymes onto the finished granules to provide a more complete detergent composition. Such techniques and ingredients are well known in the art.

### (IV). Temperature Control

A particular advantage of the inventive process over conventional wet or dry neutralization processes is the reduced temperature control requirements due to the limited partial neutralization (i.e., 5 to 20%) during the first stage. The neutralization reaction is an exothermic reaction that generates a large amount of heat. By allowing only 5 to 20% neutralization during the first stage, the reaction heat from such partial neutralization is sufficient to maintain the partially neutralized mixture at a temperature above the pumpable temperature without the need for any additional heating device, but not too much as to require any additional cooling device. The “pumpable temperature” as herein defined is the temperature at which a fluid not exhibits a viscosity of 30 Pa·s at 50 s⁻¹. In other words, fluids are considered readily pumpable if they have a viscosity of no greater than 30 Pa·s at a shear rate of 50 s⁻¹ at the temperature of pumping. Fluids of higher viscosity may still in principle be pumpable, but an upper limit of 30 Pa·s at a shear rate of 50 s⁻¹ is used herein to indicate easy pumpability.

It can be preferred that the temperature of the partially neutralized mixture is carefully monitored by one or more temperature sensors, which is then feedback into a control system for adjusting the amount of neutralizing agent added into the acid precursors of the anionic surfactant during the first stage, which correspondingly changes the partial neutralization rate and the reaction heat generated thereby.

Although not necessary, it is nevertheless possible to employ heating and cooling means into the processing system of the present invention. Specifically, it may be useful to monitor and if necessary control the temperature and thus the viscosity of each of the liquid components in the process, as well as of the combined components, whilst the process is in operation to ensure they are pumpable. Furthermore, it is preferred that any other components which can be incorporated into the process are maintained at a temperature above their respective pumpable temperatures when the process is in operation. Further, in a possible but not necessary embodiment of the present invention, the partially neutralized mixture formed after the first stage, i.e., the partial neutralization stage, of the process can be actively cooled. This can be achieved either by additional cooling means or by the addition of a diluent. Such diluent can be selected from various compounds, such as nonionic surfactants, polymers, inorganic solvents (such as water) and the like.

In a typical embodiment, the temperature of the uncombined liquid acid precursor of the anionic surfactant and the liquid neutralizing agent before commencement of the first stage is maintained below 100° C., preferably below 80° C. and more preferably below 60° C. The temperature of the partially neutralized mixture formed by combination of these two ingredients is typically maintained above 50° C., preferably above 60° C. and most preferably above 70° C., but below 120° C., preferably below 110° C., more preferably below 100° C. and most preferably below 95° C. It can be preferred that the temperature of the partially neutralized mixture so formed are carefully monitored and controlled by the degree of partial neutralization, either alone or in combination with additional heating and cooling means if necessary. It is also possible to incorporate feedback control systems into the process. For example, a temperature measuring device downstream of one or more liquid dosing devices (i.e., for dosing the liquid acid precursor of the anionic surfactant and the liquid neutralization agent) and/or cooling/heating devices can feedback readings to the liquid dosing devices and/or cooling/heating devices and vary the level of raw material dosing and/or cooling/heating so as to maintain the temperature of the partially neutralized mixture within a predetermined pumpable range. Of course, once the partially neutralized mixture has exited the static mixer (i.e. the first stage of the process has been completed) it can be allowed to cool to below its pumpable temperature.

Heating means may be positioned anywhere in the process to ensure a particular fluid component or mixture is above its pumpable temperature. Suitable heating means will be apparent to the skilled person.

Suitable cooling means will be well known to the skilled person and include, for example, pipe bundle heat exchangers, plate heat exchangers and frame heat exchangers. It can be desired, but not necessary, that at least one cooling means is provided through which the partially neutralized mixture is passed prior to any subsequent mixers or prior to any subsequent processing of such mixture. The cooling means may be positioned before, at or after the static mixer as is appropriate. Preferably, it is positioned at or around the first static mixer. Further cooling means may be positioned anywhere in the process as is appropriate to control the temperature.

### IV. Detergent Granules

The detergent granules formed by the process of the present invention preferably have a mean particle size ranging from about 50 to about 2000 microns, which spans beyond the range of acceptable average detergent particle size (about 250 to 1200 microns) to include both fines (agglomerates and particles less than 250 microns) and oversized particles (agglomerates greater than 1400 microns). More preferably, the detergent granules have a mean particle size ranging from about 250 to about 1000 microns and a bulk density that is from about 400 g/1 to about 1000 g/l, preferably from 450 g/1 to 900 g/l, and more preferably from about 500 g/1 to about 800 g/l.

Such detergent granules preferably comprise: (1) more than about 30 wt % of the anionic surfactant, which is preferably a C₁₀-C₂₀ linear alkyl benzene sulphonate and which is substantially neutralized with little or no acid residues, (2) from about 5% to 70%, preferably from 20% to 65%, more preferably from 35% to 62%, and most preferably from 45% to 60% of the additional neutralizing agent, which is preferably an alkali metal carbonate, and (3) optionally, from about 0.5% to about 25% of one or more structurants selected from the group consisting of silica, zeolite, bentonite, cellulose or derivatives thereof, phosphates, acetates, polyacrylates, acrylate-maleate copolymers, magnesium sulfate, and mixtures thereof.

The detergent granules formed by the above-described two-stage neutralization process are characterized by a sufficiently high surfactant activity (e.g., more than 30 wt % surfactant, preferably more than 35 wt % surfactant, more preferably more than 45 wt % surfactant), with sufficiently low water content and improved flowability.

Specifically, the detergent granules of the present invention contain significantly less free water or free moisture, thereby avoiding the need for subsequent drying.

Additional adjunct detersive ingredients can be incorporated into the detergent granules or the finished detergent compositions during subsequent steps of the present process. Illustrative examples of such adjunct ingredients include: (1) inorganic and/or organic builders, such as carbonates (including bicarbonates and sesquicarbonates), sulphates, phosphates (exemplified by the tripolyphosphates, pyrophosphates, and glassy polymeric meta-phosphates), phosphonates, phytic acid, silicates, zeolite, citrates, polycarboxylates and salts thereof (such as mellitic acid, succinic acid, oxydisuccinic acid, polymaleic acid, benzene 1,3,5-tricarboxylic acid, carboxymethyloxysuccinic acid, and soluble salts thereof), ether hydroxypolycarboxylates, copolymers of maleic anhydride with ethylene or vinyl methyl ether, 1,3,5-trihydroxy benzene-2,4,6-trisulphonic acid, 3,3-dicarboxy-4-oxa-1,6-hexanedioates, polyacetic acids (such as ethylenediamine tetraacetic acid and nitrilotriacetic acid) and salts thereof, fatty acids (such as C₁₂-C₁₈ monocarboxylic acids); (2) chelating agents, such as iron and/or manganese-chelating agents selected from the group consisting of amino carboxylates, amino phosphonates, polyfunctionally-substituted aromatic chelating agents and mixtures therein; (3) clay soil removal/anti-redeposition agents, such as water-soluble ethoxylated amines (particularly ethoxylated tetraethylene-pentamine); (4) polymeric dispersing agents, such as polymeric polycarboxylates and polyethylene glycols, acrylic/maleic-based copolymers and water-soluble salts thereof of, hydroxypropylacrylate, maleic/acrylic/vinyl alcohol terpolymers, polyethylene glycol (PEG), polyaspartates and polyglutamates; (5) optical brighteners, which include but are not limited to derivatives of stilbene, pyrazoline, coumarin, carboxylic acid, methinecyanines, dibenzothiphene-5,5-dioxide, azoles, 5- and 6-membered-ring heterocycles, and the like; (6) suds suppressors, such as monocarboxylic fatty acids and soluble salts thereof, high molecular weight hydrocarbons (e.g., paraffins, haloparaffins, fatty acid esters, fatty acid esters of monovalent alcohols, aliphatic C₁₈-C₄₀ ketones, etc.), N-alkylated amino triazines, propylene oxide, monostearyl phosphates, silicones or derivatives thereof, secondary alcohols (e.g., 2-alkyl alkanols) and mixtures of such alcohols with silicone oils; (7) suds boosters, such as C₁₀-C₁₆ alkanolamides, C₁₀-C₁₄ monoethanol and diethanol amides, high sudsing surfactants (e.g., amine oxides, betaines and sultaines), and soluble magnesium salts (e.g., MgCl₂, MgSO₄, and the like); (8) fabric softeners, such as smectite clays, amine softeners and cationic softeners; (9) dye transfer inhibiting agents, such as polyvinyl pyrrolidone polymers, polyamine N-oxide polymers, copolymers of N-vinylpyrrolidone and N-vinylimidazole, manganese phthalocyanine, peroxidases, and mixtures thereof; (10) enzymes, such as proteases, amylases, lipases, cellulases, and peroxidases, and mixtures thereof; (11) enzyme stabilizers, which include water-soluble sources of calcium and/or magnesium ions, boric acid or borates (such as boric oxide, borax and other alkali metal borates); (12) bleaching agents, such as percarbonates (e.g., sodium carbonate peroxyhydrate, sodium pyrophosphate peroxyhydrate, urea peroxyhydrate, and sodium peroxide), persulfates, perborates, magnesium monoperoxyphthalate hexahydrate, the magnesium salt of metachloro perbenzoic acid, 4-nonylamino-4-oxoperoxybutyric acid and diperoxydodecanedioic acid, 6-nonylamino-6-oxoperoxycaproic acid, and photoactivated bleaching agents (e.g., sulfonated zinc and/or aluminum phthalocyanines); (13) bleach activators, such as nonanoyloxybenzene sulfonate (NOBS), tetraacetyl ethylene diamine (TAED), amido-derived bleach activators including (6-octanamidocaproyl)oxybenzenesulfonate, (6-nonanamidocaproyl)oxybenzenesulfonate, (6-decanamidocaproyl)oxybenzenesulfonate, and mixtures thereof, benzoxazin-type activators, acyl lactam activators (especially acyl caprolactams and acyl valerolactams); and (9) any other known detergent adjunct ingredients, including but not limited to carriers, hydrotropes, processing aids, dyes or pigments, and solid fillers.

### Test Methods

The following techniques must be used to determine the properties of the detergent granules and detergent compositions of the invention in order that the invention described and claimed herein may be fully understood.

### Test 1: Bulk Density Test

The granular material bulk density is determined in accordance with Test Method B, Loose-fill Density of Granular Materials, contained in ASTM Standard E727-02, “Standard Test Methods for Determining Bulk Density of Granular Carriers and Granular Pesticides,” approved Oct. 10, 2002.

### Test 2: Sieve Test

This test method is used herein to determine the particle size distribution of the agglomerated detergent granule's of the present invention. The particle size distribution of the detergent granules and granular detergent compositions are measured by sieving the granules through a succession of sieves with gradually smaller dimensions. The weight of material retained on each sieve is then used to calculate a particle size distribution.

This test is conducted to determine the Median Particle Size of the subject particle using ASTM D 502-89, “Standard Test Method for Particle Size of Soaps and Other Detergents”, approved May 26, 1989, with a further specification for sieve sizes used in the analysis. Following section 7, “Procedure using machine-sieving method,” a nest of clean dry sieves containing U.S. Standard (ASTM E 11) sieves #8 (2360 μm), #12 (1700 μm), #16 (1180 μm), #20 (850 μm), #30 (600 μm), #40 (425 μm), #50 (300 μm), #70 (212 μm), and #100 (150 μm) is required. The prescribed Machine-Sieving Method is used with the above sieve nest. The detergent granule of interest is used as the sample. A suitable sieve-shaking machine can be obtained from W.S. Tyler Company of Mentor, Ohio, U.S.A. The data are plotted on a semi-log plot with the micron size opening of each sieve plotted against the logarithmic abscissa and the cumulative mass percent (Q3) plotted against the linear ordinate.

An example of the above data representation is given in ISO 9276-1:1998, “Representation of results of particle size analysis—Part 1: Graphical Representation”, Figure A.4. The Median Weight Particle Size (Dw50) is defined as the abscissa value at the point where the cumulative weight percent is equal to 50 percent, and is calculated by a straight line interpolation between the data points directly above (a50) and below (b50) the 50% value using the following equation:

D_{w}50=10[Log(Dₐ₅₀)−(Log(Dₐ₅₀)−Log(D_{b50}))*(Qₐ₅₀−50%)/(Qₐ₅₀−Q_{b50})]

where Qₐ₅₀ and Q_{b50} are the cumulative weight percentile values of the data immediately above and below the 50^{th} percentile, respectively; and Dₐ₅₀ and D_{b50} are the micron sieve size values corresponding to these data. In the event that the 50^{th} percentile value falls below the finest sieve size (150 μm) or above the coarsest sieve size (2360 μm), then additional sieves must be added to the nest following a geometric progression of not greater than 1.5, until the median falls between two measured sieve sizes.

### Example I

An aqueous surfactant acid precursor, HLAS, having an activity of 97%, with 1% free water, 1% H2SO4 and 1% miscellaneous, is pumped via a positive displacement pump into a static mixer at the rate of 3300 kg/hr. A caustic solution, NaOH, having an activity of 50%, is also pumped into the static mixer at the rate of 120 kg/hr. The mixture after static mixer is pumped into a Lodige CB 75 at a rate of 3420 kg/hr. At the same time, a powder stream containing sodium carbonate is also fed into Lodige CB 75 mixer at a rate of 6.5 ton/hr. Also flowing into the same mixer are two streams containing the recycle of the classification of the agglomerates, one containing wet coarse particles and the other dry fine particles. The agglomerates leaving the Lodige CB75 mixer are feed into a Lodige KM 4200 mixer. After that, the agglomerates are feed into a fluid bed drier with air inlet temperature range from 90 C to 140 C. The air inlet temperature and air flow are adjusted so that the agglomerates out of the fluid bed drier reach the final moisture below 1.5%. The agglomerates leaving the fluid bed drier are then feed into a fluid bed cooler to reach the powder exit temperatures below 50 C. The cool dry product leaving the cooler is classified through mesh sieves and desired particle sizes stored in a silo. The agglomerates made during this example have a detergent activity of 35%. The partial neutralization achieved during first mixing step is about 8%.

### Example II

An aqueous surfactant acid precursor, HLAS, having an activity of 97%, with 1% free water, 1% H2SO4 and 1% miscellaneous, is pumped via a positive displacement pump into a static mixer the rate of 3300 kg/hr. A caustic solution, NaOH, having an activity of 50%, is also pumped into the static mixer at the rate of 180 kg/hr. The mixture after static mixer is passed through a heat exchanger to reduce the temperature to 70 C. Then the mixture is pumped into a Lodige CB 75 at a rate of 3480 kg/hr. At the same time, a powder stream containing sodium carbonate is also fed into Lodige CB 75 mixer at a rate of 6.5 ton/hr. Also flowing into the same mixer are two streams containing the recycle of the classification of the agglomerates, one containing wet coarse particles and the other dry fine particles. The agglomerates leaving the Lodige CB75 mixer are feed into a Lodige KM 4200 mixer. After that, the agglomerates are feed into a fluid bed drier with air inlet temperature range from 90 C to 140 C. The air inlet temperature and air flow are adjusted so that the agglomerates out of the fluid bed drier reach the final moisture below 1.5%. The agglomerates leaving the fluid bed drier are then feed into a fluid bed cooler to reach the powder exit temperatures below 50 C. The cool dry product leaving the cooler is classified through mesh sieves and desired particle sizes stored in a silo. The agglomerates made during this example have a detergent activity of 35%. The partial neutralization achieved during first mixing step is about 16%.

### Example III

An aqueous surfactant acid precursor, HLAS, having an activity of 97%, with 1% free water, 1% H2SO4 and 1% miscellaneous, is pumped via a positive displacement pump into a static mixer the rate of 330 kg/hr. A caustic solution, NaOH, having an activity of 50%, is also pumped into the static mixer at the rate of 10 kg/hr. The mixture after static mixer is pumped into a water jacketed storage tank with the temperature of the jacket controlled from 50 C to 80 C. 22 kg sodium carbonate powder material is added into a batch agglomeration ploughshare mixer. 8 kg HLAS/NaOH mixture is then pumped via a positive displacement pump into the ploughshare mixer at 2 kg per minute rate. The liquid mixture is added onto the chopper location. After liquid mixture dosing, stop the mixer, then add another 0.07 kg zeolite into the batch mixer. Continuously run the mixer for another 2 min. The final product is a free flowing detergent granule. The partial neutralization achieved during first mixing step is about 6%.

### Example IV

Eleven kilograms (11 kg) of aqueous surfactant acid precursor, HLAS, having an activity of 97%, with 1% free water, 1% H2SO4 and 1% miscellaneous, is added into an agitated 20 L tank with water jacket set at 60 C. Sodium carbonate slurry is made separately by mixing 300 gram of sodium carbonate with 70 gram of water. Both sodium carbonate and water are kept at temperature 50 C before mixing. The slurry is then added into the agitated storage tank to react with HLAS by manually pour in over 2 min. The partial neutralized mixture is then passing through a high shear mill for recirculation for about 2 min. Twenty two kilograms (22 kg) of sodium carbonate powder material is added into a batch agglomeration ploughshare mixer. The HLAS/Carbonate mixture made via first step is then pumped via a positive displacement pump into the ploughshare mixer at 2 kg per minute rate. The liquid mixture is added onto the chopper location. After liquid mixture dosing, stop the mixer, then add another 0.07 kg zeolite into the batch mixer. Continuously run the mixer for another 2 min. The final product is a free flowing detergent granule. The partial neutralization achieved during first HLAS/Carbonate mixing step is about 10%.

### Example V

The following comparative test is carried out to demonstrate the flowability differences between detergent granules containing the same amount of LAS surfactant by formed with different partial neutralization rates during the first stage of processing and then fully neutralized during the second stage of processing with the same amount of excessive neutralizing agent in the final detergent granules.

### Test Procedure:

1. An inventive detergent granule sample A is made by two steps. The first step is to prepare a partially neutralized mixture having 12.4% neutralization, which is formed by first adding 6.2 grams of an aqueous caustic solution that contains 50% NaOH and 50% water into 136.0 grams of liquid HLAS (containing 96.7% HLAS) and then stirring until a homogenous phase is formed. The second step is to mix the partially neutralized mixture so formed in a BRAUN CombiMax K600 food mixer with 266.0 grams of solid sodium carbonate powder having an average particle size of 20 microns at a temperature of about 60° C. and a speed of grade 8 for 30 seconds, thereby forming 400.3 grams of the inventive detergent granule sample A with a surfactant activity of about 35% (i.e., containing 35% NaLAS).
2. A comparative detergent granule sample B is also made by two steps. The first step is to prepare a partially neutralized mixture having 31.2% neutralization, which is formed by first adding 12.3 grams of the same aqueous caustic solution as described hereinabove into 135.4 grams of HLAS (same as described hereinabove) and then stirring until a homogenous phase is formed. The second step is to mix the partially neutralized mixture so formed in the same BRAUN CombiMax K600 food mixer with 258.8 grams of solid sodium carbonate powder (same as described hereinabove) at a temperature of 60° C. and a speed of grade 8 for 30 seconds, thereby forming 400.3 grams of the comparative detergent granule sample B with a surfactant activity of about 35% (i.e., containing 35% NaLAS).
3. The final compositional breakdowns of the inventive sample A (with 12.4% neutralization during the first step of partial neutralization) and the comparative sample B (with 31.2% neutralization during the first step of partial neutralization) are tabulated as follows:

TABLE I

| Recipe | Inventive Sample A | Comparative Sample B |
|---|---|---|
| HLAS | 33.3% | 33.3% |
| Caustic | 1.5% | 3.0% |
| Carbonate | 65.2% | 63.7% |
| Total | 100% | 100% |

TABLE II

| Final Composition | Inventive Sample A | Comparative Sample B |
|---|---|---|
| NaLAS | 35.1% | 35.0% |
| Carbonate | 60.5% | 60.0% |
| Moisture | 2.2% | 3.1% |
| Misc. | 2.2% | 1.9% |
| Total | 100.00% | 100.00% |

4. The particle size distributions (PSD) of samples A and B are measured using ASTM D 502-89, “Standard Test Method for Particle Size of Soaps and Other Detergents”, approved May 26, 1989, with a further specification for sieve sizes and sieve time used in the analysis. The measurement is carried out by following the Machine-Sieving Method using sieves #16 (1180 um), #25 (710 um), #30 (600 um), #40 (425 um), #60 (250 um), #100 (150 um). A suitable sieve-shaking machine can be obtained from W.S. Tyler Company, Ohio, U.S.A. The sieve-shaking test sample is approximately 100 grams and is shaken for 5 minutes. The measurement results are plotted on a semi-log plot with the micron size opening of each sieve plotted against the logarithmic abscissa and the cumulative mass percent (Q3) plotted against the linear ordinate. An example of the above data representation is given in ISO 9276-1:1998, “Representation of results of particle size analysis—Part 1: Graphical Representation”, Figure A.4. The median particle size (D50), for the purpose of this invention, is defined as the abscissa value at the point where the cumulative mass percent is equal to 50 percent, and is calculated by a straight line interpolation between the data points directly above (a50) and below (b50). The 50% value using the following equation:

D50=10̂[Log(Da50)−(Log(Da50)−Log(Db50))*(Qa50−50%)/(Qa50−Qb50)],
wherein Qa50 and Qb50 are the cumulative mass percentile values of the data immediately above and below the 50th percentile, respectively; and Da50 and Db50 are the micron sieve size values corresponding to these data.

D10 and D90 are following the same method as D50.

The particle size distribution of samples A and B are shown as below:

TABLE III

| PSD | Inventive Sample A | Comparative Sample B |
|---|---|---|
| D50 | 344 | 355 |
| D10 | 146 | 133 |
| D90 | 731 | 710 |

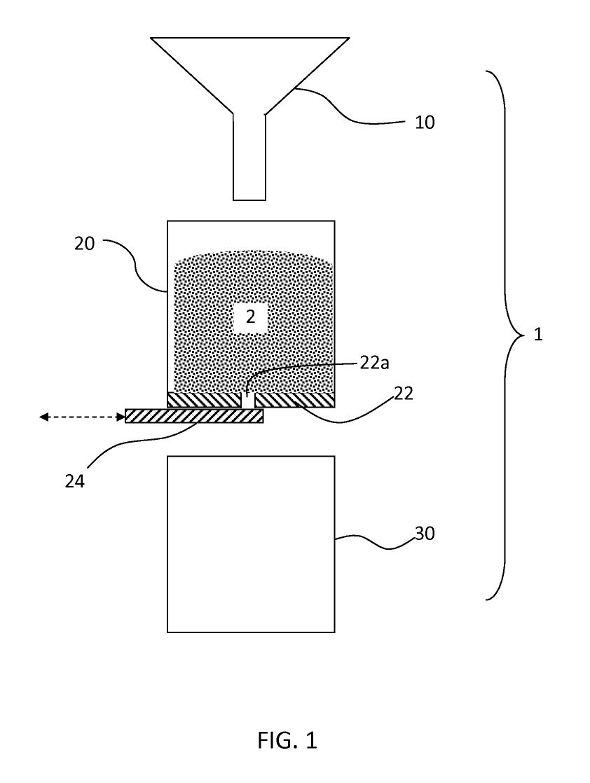

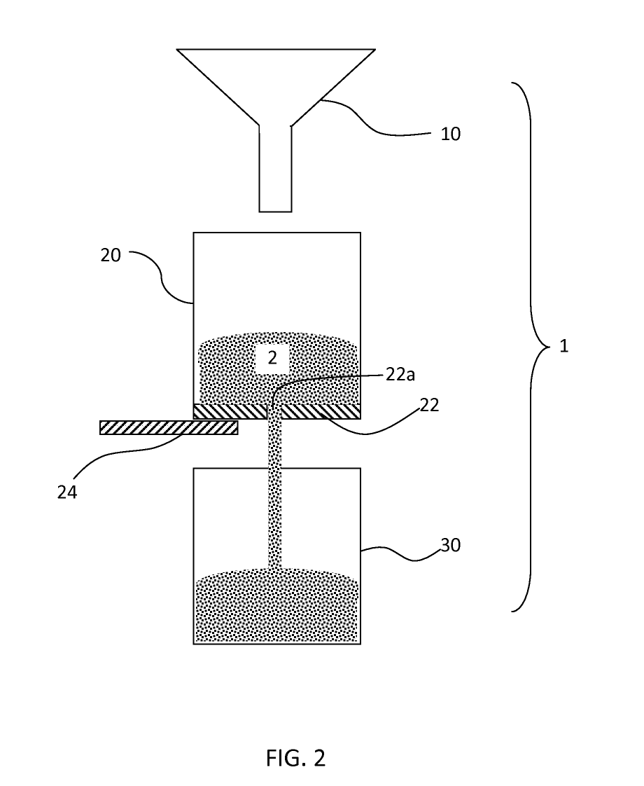

It is clear from the above table that the inventive sample A and the comparative sample B have similar particle size distributions.
5. FlowDex Test for Measuring Flowability
   The device adapted for this method is a commercially available flowability testing system, Flodex™ (Hanson Research, Chatsworth, Calif., USA), which contains a flat-bottom cylindrical hopper with a removable bottom and a set of interchangeable bottom disks containing therein orifices of different sizes. Further, additional bottom disks with orifices of smaller sizes (with diameters below 4 mm) are made so as to provide a more complete range of orifice diameters including 3.0 mm, 3.5 mm, 4.0 mm, 5.0 mm, 6.0 mm, 7.0 mm, 8.0 mm, 9.0 mm, 10.0 mm, 12.0 mm, 14.0 mm. FIGS. 1 and 2 are cross-sectional diagrams illustrating how the FlowDex equipment functions to carry out the flowability measurement. Specifically, the FlowDex equipment 1 includes a funnel 10 for loading a particulate test sample 2 into a stainless steel flat-bottom cylindrical hopper 20 having a diameter of about 5.7 cm. The hopper 20 has a removable bottom defined by a removal bottom disk 22 with an orifice 22a of a specific size therein. Multiple removal bottom disks (not shown) having orifices of different sizes are provided, as mentioned hereinabove, which can be interchangeably fit at the bottom of hopper 20 in place of disk 22 to thereby define a bottom orifice of a different size from 22a. A discharge gate 24 is placed immediately underneath the orifice 22a and above a receiver 30, as shown in FIG. 1. When the flowability measurement starts, the discharge gate 24 is moved so as to expose the bottom orifice 22a and allow the particulate test sample 2 to flow from the hopper 20 through the bottom orifice 22a down to the receiver 30, as shown in FIG. 2.

To test the flowability of a specific test sample, the following steps are followed:
5.1. Fill the hopper 20 by pouring about 125 ml of the test sample through funnel 10. The sample fills the 5.7 cm-diameter hopper 20 to a height of about 5 cm.
5.2. After the sample settles, open the spring-loaded discharge gate 24 and allow the sample to flow through the orifice 22a into the receiver 30.
5.3. Steps 5.1 and 5.2 are repeated for the same test sample using different bottom disks having orifices of gradually increasing orifice sizes. At the beginning when the bottom disks with relatively smaller orifices are used, the flow of the test sample typically stops at some point due to jamming, i.e., it cannot pass through the orifice due to the small orifice size. Once the flow of test sample stops and remains stopped for 30 seconds or more, a jam is declared, and the specific bottom disk causing the jam is removed and replaced by another bottom disk with an orifice that is slightly larger for another repeat of steps 5.1 and 5.2. When the test sample is able to flow completely through an orifice of a specific size for three (3) consecutive times without jamming, such orifice size is recorded as the FlowDex Blockage Parameter of the sample tested. The smaller the FlowDex Blockage Parameter, the better the flowability of the test sample (i.e., it can flow through smaller orifices without jamming).

Following are the flowability test results:

| | Inventive Sample A | Comparative Sample B |
|---|---|---|
| FlowDex Blockage | 6 mm | 12 mm |
| Parameter | | |

Despite the fact that the inventive sample A and the comparative sample B have similar particle size distributions, as shown hereinabove, the inventive sample A exhibit significantly better flowability than the comparative sample B, which is both surprising and unexpected.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for preparing detergent granules, comprising the steps of:
(a) mixing a liquid acid precursor of an anionic surfactant and a first neutralizing agent, wherein said first neutralizing agent is provided in an amount sufficient for neutralizing from 5% to 20% by weight of said liquid acid precursor of the anionic surfactant to form a partially neutralized mixture; and
(b) subsequently, mixing the partially neutralized mixture with a second neutralizing agent, wherein said second neutralizing agent is provided in an amount sufficient for substantially neutralizing the remaining liquid acid precursor of the anionic surfactant in the partially neutralized mixture to form detergent granules.

2. The process of claim 1, wherein in step (a), the first neutralizing agent is provided in an amount sufficient for neutralizing from 10% to 18%, preferably from 15% to 17%, by weight of said liquid acid precursor of the anionic surfactant.

3. The process of claim 1, wherein in step (a), the first neutralizing agent is in a liquid form and preferably comprises an aqueous solution of an alkali metal hydroxide, and wherein said alkali metal hydroxide is preferably sodium hydroxide.

4. The process of claim 1, wherein in step (a), the first neutralizing agent is in a liquid form and preferably comprises a slurry of alkali metal carbonate or bicarbonate particles dispersed in a liquid carrier, and wherein said alkali metal carbonate or bicarbonate is preferably sodium carbonate.

5. The process of claim 1, wherein the liquid acid precursor of the anionic surfactant comprises a C₁₀-C₂₀ linear alkyl benzene sulphonic acid, which is preferably provided in a substantially pure form.

6. The process of claim 1, wherein step (a) is carried out using one or more in-line mixers selected from the group consisting of static in-line mixers, dynamic in-line mixers, and combinations thereof.

7. The process of claim 1, wherein in step (b), the second neutralizing agent is in a solid form and preferably comprises an alkali metal carbonate or alkali metal bicarbonate, which is preferably sodium carbonate.

8. The process of claim 7, wherein the second neutralizing agent is provided in a stoichiometrically excessive amount in relation to the remaining liquid acid precursor of the anionic surfactant in the partially neutralized mixture.

9. The process of claim 8, wherein the second neutralizing agent is provided in an amount sufficient for forming detergent granules that comprises from 5% to 70%, preferably from 20% to 65%, more preferably from 35% to 62%, and most preferably from 45% to 60% of said second neutralizing agent by total weight of said detergent granules.

10. The process of claim 1, wherein step (b) is carried out using one or more batch mixers selected from the group consisting of paddle mixers, extruder mixers, ribbon blenders, ploughshare mixers, pin mixers, drum mixers, and combinations thereof.

11. The process of claim 1, wherein a dryer is used to remove free moisture from the detergent granules, said dried detergent granules comprising less than 2%, preferably less than 1.6%, more preferably less than 1.2% of free moisture by total weight of said dried detergent granules.

12. The process of claim 1, further comprising the step of:
(c) collecting over-sized particles having a mean particle size of more than 1400 um, preferably more than 1200 um, from the detergent granules after step (b);
(d) grinding said over-sized particles to reduce their particle size; and
(e) recycling the grinded over-sized particles.

13. The process of claim 12, further comprising the steps of:
(f) collecting fine particles having a mean particle size of less than 250 um, preferably less than 200 um, from the detergent granules after step (b) preferably by using a fluid bed; and
(g) recycling said fine particles.

14. The process of claim 1, wherein the liquid acid precursor of the anionic surfactant is provided in an amount sufficient for forming detergent granules that comprises more than 30%, preferably more than 35% and more preferably more than 40%, of said anionic surfactant by total weight of said detergent granules.

15. The process of claim 1, wherein in step (b), the partially neutralized mixture is further mixed with one or more structurants selected from the group consisting of silica, zeolite, bentonite, cellulose or derivatives thereof, phosphates, acetates, polyacrylates, acrylate-maleate copolymers, magnesium sulfate, and mixtures thereof in an amount sufficient for forming detergent granules comprising from 0.5% to 25% of said one or more structurants by total weight of the detergent granules.

16. The process of claim 1, further comprising the step of mixing one or more structurants selected from the group consisting of silica, zeolite, bentonite, cellulose or derivatives thereof, phosphates, acetates, polyacrylates, acrylate-maleate copolymers, magnesium sulfate, and mixtures thereof with the detergent granules after step (b), thereby forming a coating of structurant(s) over the detergent granules, and wherein said coating of structurant(s) is provided in an amount ranging from 0.2% to 5% by total weight of the coated detergent granules.

17. A process for preparing detergent granules, comprising the steps of:
(a) mixing a substantially pure C₁₀-C₂₀ linear alkyl benzene sulphonic acid, or a solution thereof containing at least 90 wt % of such C₁₀-C₂₀ linear alkyl benzene sulphonic acid, with an aqueous solution of sodium hydroxide or a slurry of sodium carbonate dispersed in water in an in-line static mixer, wherein the sodium hydroxide or sodium carbonate is provided in an amount sufficient for neutralizing from 15% to 17% by weight of the C₁₀-C₂₀ linear alkyl benzene sulphonic acid to form a partially neutralized mixture; and
(b) subsequently, mixing the partially neutralized mixture with solid sodium carbonate powder, wherein the solid sodium carbonate powder is provided in an amount sufficient for substantially neutralizing the remaining C₁₀-C₂₀ linear alkyl benzene sulphonic acid in the partially neutralized mixture to form detergent granules that contain.
